(19) United States
(12) Patent Application Publication
(10) Pub. No.: US 2012/0072239 A1
(43) Pub. Date: Mar. 22, 2012

(54) SYSTEM AND METHOD FOR PROVIDING A HOME HISTORY REPORT

(76) Inventors: David L. Gibbard, Suwanee, GA (US); Craig A. Cuddeback, Atlanta, GA (US)

(21) Appl. No.: 12/888,210

(22) Filed: Sep. 22, 2010

(51) Int. Cl. G06Q 40/00; G06F 17/30; G06Q 30/00

(52) U.S. Cl. 705/4; 707/758; 707/E17.008

(57) ABSTRACT

A system for creating a report includes a server configured (i) to retrieve public information from publicly available data sources and (ii) to retrieve private information from a private date source, each of which is based upon input from a user; an interface to an retrieve insurance quote based upon the input, wherein the server is further configured to generate a report comprising the public information and private information and the insurance quote.

### CROSS-REFERENCE TO RELATED APPLICATION

The subject matter disclosed in this patent application is related to the subject matter disclosed and claimed in the following U.S. Provisional Patent Application Ser. No. XX/XXX,XXX, Attorney Docket No. HCLU-0003, titled “SYSTEM AND METHOD FOR EVALUATING A PROPERTY,” filed concurrently on Sep. 22, 2010, the entirety of which is hereby incorporated by reference.

### TECHNICAL FIELD

This disclosure is directed to a system and method for compiling and reporting a history of a home or other real property.

### BACKGROUND

Purchasing a home is typically among the biggest investments any person makes. In purchasing an existing home, the prospective purchaser has an information disadvantage vis-à-vis the seller. The seller knows the entire history of the home—at least for the portion of time that the seller has lived in the home—while the buyer knows relatively little about the history of the home. The buyer may rely on some pieces of information, for example, in some states, the seller is required to complete a disclosure report wherein the seller discloses the problems with the home to the buyer. The mandatory disclosure is still somewhat voluntary and subject to skepticism, as partial and misleading statements may mask the truth. Even if the seller is honest, the disclosure report is still subject to certain limitations, including but not limited to the memory of the seller. Moreover, the seller may not know the history of the home prior to the seller having possession of the home.

The buyer may also dig through city or county property records for tax and other official information. The buyer may also access some publicly available data to determine the presence of flood plains, environmental hazards or natural disaster trends and histories. The buyer may even interview neighbors in an effort to solicit more information about the property. Regardless of the number of additional steps the buyer takes, the information is still subject to error, misinformation and fraud.

Accordingly, there is a need for a data gathering and reporting system which provides complete and accurate information about a property to a sell

### SUMMARY

There is described a system for creating a report, including a data processor configured (i) to retrieve public information from publicly available data sources and (ii) to retrieve private information from a private date source, each of which is based upon input from a user, an interface to an retrieve insurance quote based upon the input; and wherein the server is further configured to generate a report comprising the public information and private information and the insurance quote. The disclosed system may further include an authentication system configured to qualify the user for access to the private information and an application programming interface configured to provide access to the server by a third party application. There may also be an e-commerce module configured to execute a business transaction relating to the report. The private information may include an insurance history.

There is also described a method including requesting data from publicly available data sources, obtaining an insurance quote; receiving insurance history information, generating a report comprising the data from publicly available data sources, the insurance history information, and the insurance quote. The method may also include authenticating the user as a prospective purchaser and wherein the receiving insurance history information step is performed responsive to the authentication step. An alternative method of generating home report includes requesting data from publicly available data sources, obtaining data from data sources not generally available to the public, and generating a report comprising the data from publicly available data sources and the data sources not generally available to the public. The alternative method may also include authenticating the user as a prospective purchaser and wherein the obtaining step is performed responsive to the authentication step.

The present disclosure is also directed to a tangible storage medium having stored thereon computer-executable instructions for generating a home history report, by requesting data from publicly available data sources, obtaining an insurance quote, receiving insurance history information, and generating a report comprising the data from publicly available data sources, the insurance history information, and the insurance quote. The computer-executable instructions also include authenticating the user as a prospective purchaser and wherein the receiving insurance history information step is performed responsive to the authentication step.

### BRIEF DESCRIPTION OF THE DRAWINGS

The following description is better understood when read in conjunction with the appended drawings, wherein

FIG. 1 is a block diagram illustration of an embodiment of the disclosed system;

FIG. 2 is a block diagram illustrating the functions of the disclosed system;

FIGS. 3a through 3i are sample pages from an exemplary report generated by the disclosed system; and

FIG. 4 is a flow chart illustrating an exemplary method of the disclosure.

### DETAILED DESCRIPTION OF ILLUSTRATIVE EMBODIMENTS

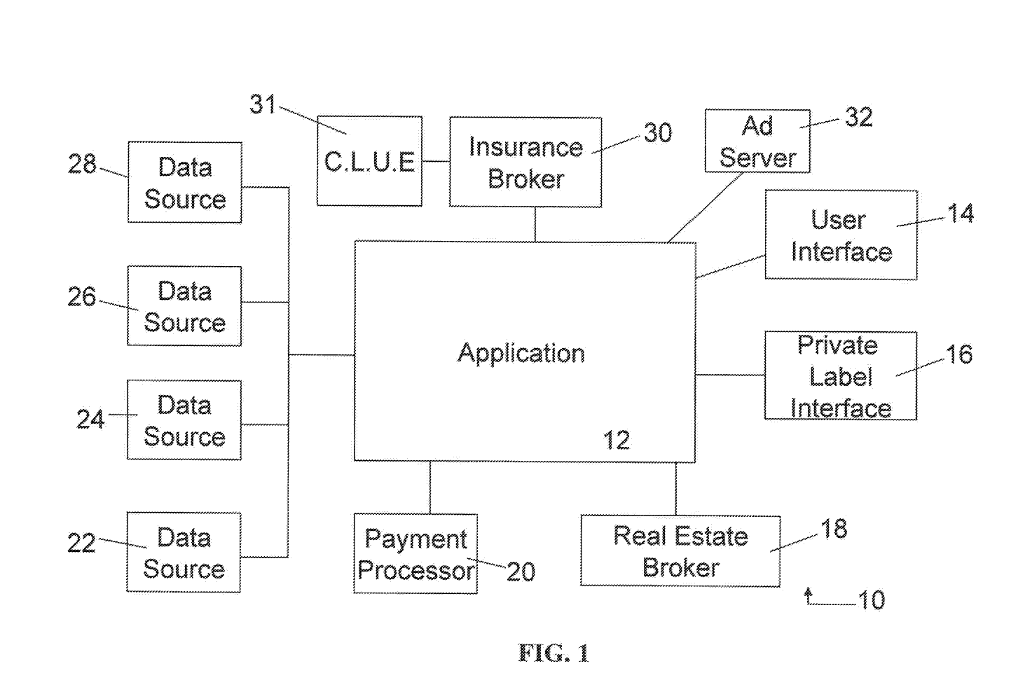

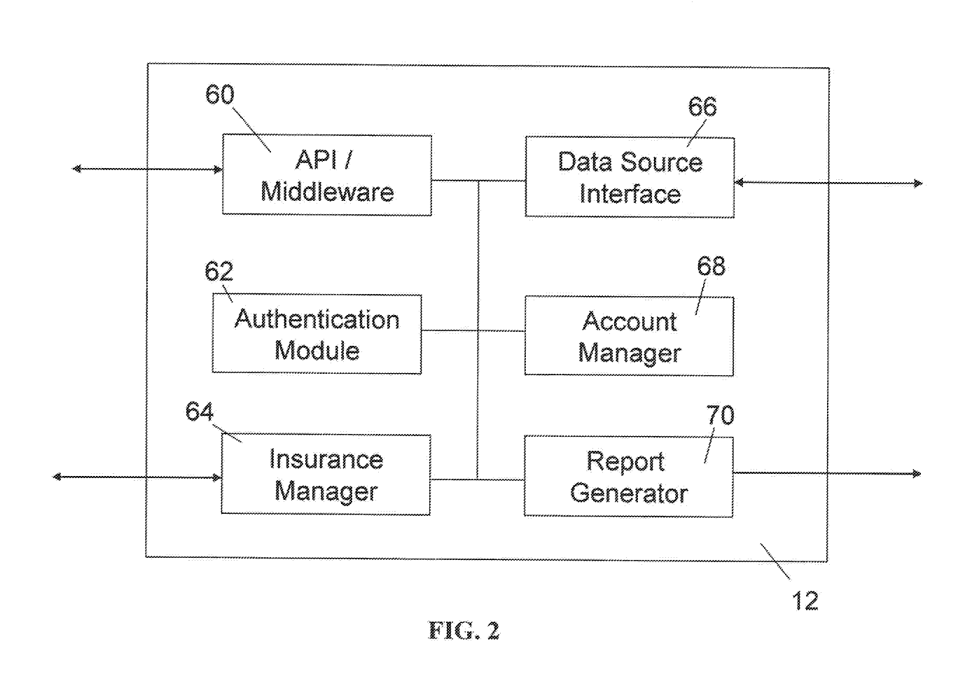

For the purposes of describing an exemplary embodiment of the disclosure, reference will be made to the figures set forth above. With reference to FIG. 1, there is shown a system 10 including a data processing application 12 central to the system 10. The data processing application 12 may be a computer program which resides on a server connected to a network such as the internet, a stand alone computer, in a cloud, or on any other host in a computing environment. The data processing application 12, described in more detail in FIG. 2, interfaces with a user interface 14. The user interface 14 may be a portal on a website operated on behalf of the proprietor or user of the data processing application and may, for example, be the home page for accessing the data processing application 12. The user interface 14 is configured for receiving input from users which, as set forth in more detail below, may be home owners or prospective purchasers or lessees of homes or other real property. The user interface 14 is also configured for receiving home or real property reports created by the data processing application. It will be understood that there may be various users of this system 10, including home buyers, home sellers, homeowners, insurers, mortgage providers and brokers, real estate professionals, home inspectors, and other users who have an interest in home history or home scoring. The permissions and/or authentications for access various components may vary and may be a function of the type of user. For example, a homeowner may have full access to the history of the home including insurance history reports, a qualified home buyer or prospective home buyer may have similar access as the homeowner and additionally receive an insurance quote, and others may have access to the home history but not to the insurance history.

As an alternative to the user interface 14, the data processing application 14 may also interface with one or more private label interfaces 16. A private label interface 16 may, for example, be a home page branded by a third party that contains a plug-in applet or link to the data processing application 16. While described as home pages, those skilled in the art will also recognize that the user interface 14 and the one or more private label interfaces 16 may also include applications running on smart phones such as the Apple iPhone® or other smart phones running the Android® operating system or any other interface for allowing users to access the data processing application 12.

Also in communication with the data processing application 12 is a real estate broker 18. A real estate broker may, for example, be a computer running real estate applications and storing real estate sales information and other data. For example, the real estate broker 18 may include accessible data bases including real estate contracts and proposed contracts, property descriptions, sales and commission pricing, regional and neighborhood demographic data, and other data typically associated with that collected or maintained by a real estate broker. In the present disclosure, the real estate broker 18 may include the sales contract entered into by a seller and a prospective purchaser identifying with certainty a property to be acquired by the prospective purchaser upon closing of the transaction. The data processing application 12 may access this sales contract as part of its authentication process being executed by authentication manager 62 in FIG. 2.

Continuing with a description of FIG. 1, there is shown a payment processor 20 which is in communication with the data processing application server 12. The payment processor 20 may be a computer system or network operated by a third party payment processor such as VISA®, MasterCard®, or any other credit card, banking or financial institution. Typical operation of payment processor 20 is known by those skilled in the art.

Also in communication with data processing application server 12 are one or more data sources, shown in FIG. 1 as 22, 24, 26 and 28. It will be understood that the while only four data sources are shown, relevant information may be obtained from additional data sources or may all be obtained from a single data source. Data source 22, 24, 26, 28 may contain publicly accessible data bases that include information relevant to home buyers. While not an exhaustive list, the relevant information obtainable from one or more of the data sources 22, 24, 26, 28 may include:
Building permits which show what was repaired or added-on, which may also include why the repair was necessary;
Flood plain mapping and related information;
Federal Emergency Management Agency (FEMA) reports relating to hurricane, flood, earthquake, and other disaster relief efforts;
Environmental Protection Agency (EPA) data, including but not limited to positive radon tests mapped by address and surrounding area;
High risk environmental factors, including but not limited to proximity to landfill, toxic waste sites, superfund sites;
Ownership history; and
Mortgage history.

It will be understood that the above list is illustrative only and the actual relevant information may include subsets of the above information or more that information listed above.

Continuing with the description of FIG. 1, also in communication with the data application is insurance broker 30. Insurance broker 30 may be a computer or other server which provides insurance information and insurance quotes to the data processing application 12. The insurance broker 30 may have interfaces to one or more insurance providers which may provide one or more insurance quotes customized based on the particular home or real property being considered and the prospective purchaser of the home or real property. The insurance broker 30 may also be in communication with C.L.U.E. database 31. C.L.U.E. is a comprehensive insurance claims database maintained by Lexis/Nexis that is typically accessible by the insurance industry but is not otherwise generally available to the public. The insurance broker 30, in addition to providing insurance quotes, may query the C.L.U.E. database for insurance information particular to the home or real property under consideration and pass that information, along with the insurance quotes, back to the data processing application 12. It will be understood that access to other insurance databases may also be included, and may, for example, include the A-PLUS insurance database maintained by ISO.

Finally, FIG. 1 also shows an advertising server 32. The advertising server 32 may provide general advertising material or targeted customized, location-based advertising particular to the home or real property under consideration to the data processing application 12.

Other interfaces to the data application program 12 may include one or more interfaces to social networking sites including but not limited to YouTube®, Facebook®, or Twitter® (not shown), one or more interfaces to enterprise applications (not shown) operating in either a “software as a service” or “platform as a service” mode. It will also be understood that there may be additional interfaces to blogs, news feeds, user groups and the like.

Turning to FIG. 2, exemplary functionality of the data processing application 12 is shown. It will be understood that the exemplary functionality is for illustrative purposes only and there may be more or less functionality included in the data processing application 12. It will also be understood that functions common to general computer applications is not shown, including but not limited to user interfaces such as touch screens, keyboards, displays and printers, and computer readable media such as random access memory, programmable read only memory, and other storage media for storing programs, user information, accounting and other data. The data processing application 12 may include application programming interfaces (APIs) and/or middleware 60. The API/middleware 60 may have interfaces to external programs and computers, including user interface 14 or one or more private label interfaces 16 or any of a number of external programs (including marketing, finance and accounting programs) (not shown) that may access the data processing application 12.

The data processing application 12 may also include an authentication module 62. The authentication module 62 may validate the identity of the user or the user's representative or agent. The authentication module 62 may also include confirming that the home or real property under consideration is in fact under contract with the user. Such confirmation may be required to comply with the laws or regulations relating to the insurance quotes or accessing the insurance information from the C.L.U.E. database 31. The authentication module 62 may have access to the information from the real estate broker 18 relating to sales contracts and real property descriptions to use in the authentication, validation and confirmation processes.

Continuing with the description of FIG. 2, there is also shown an insurance manager 64. The insurance manager 64 utilizes information from the real estate broker 18 and the authentication module 62 to interface with the insurance broker 30 functionality. The insurance manager 64 may, for example, obtain multiple insurance quotes from third party insurers and brokers in a competitive bid process to enhance the value to the prospective purchaser. Additionally, the insurance manager 64 will manage access to the insurance broker 30 for purposes of obtaining the insurance claims history of the home or real property under consideration. Insurance claim information may include some or all claims filed against the home, including but not limited to hail damage, fire, theft or other type of losses.

There is also shown a data source interface 66 which functionality may include querying the one or more data sources 22, 24, 26, 28. The queries may be customized based on a number of factors, including but not limited to user specific requests, property specific requests, state or local ordinances relating to required and optional disclosures, or any other selection criteria.

Also shown is an account manager 68 functionality. The account manager 68 may manage the account of individual users, the account of real estate agents or brokers who may manage accounts on behalf of individual users, or any other user accessing the system. The account manager 68 may include interfacing to the payment processor 20 when appropriate in order to process payment for a home report requested by the user. The account manager 68 may also include other administrative functionality common to computer applications, including but not limited to managing user profile information, passwords, encryption, communication preferences, report format preferences and the like.

Finally, there is shown a report generator 70. The report generator compiles all of the requested information from the various data sources, 22, 24, 26, 28, the insurance broker 30, the real estate broker 18 and any other source of data and generates a report for the user. The report may be sent electronically to the user interface 14 or the private label interface 16, may be printed and mailed, or emailed based on the preferences of the user and the data processing system 12 capabilities.

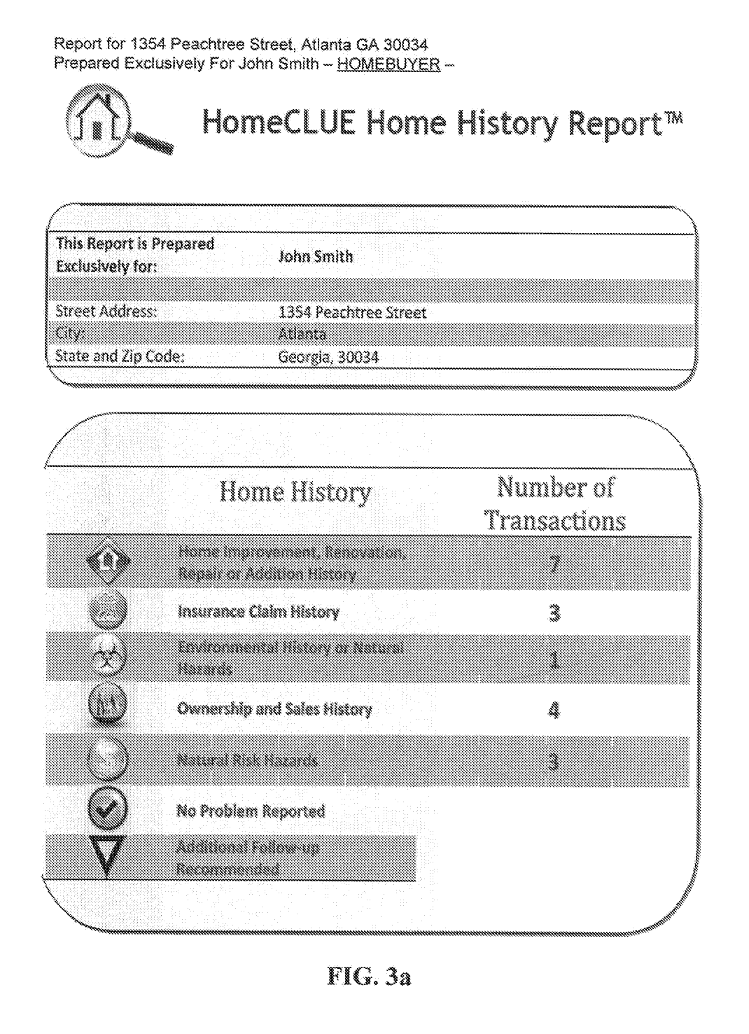

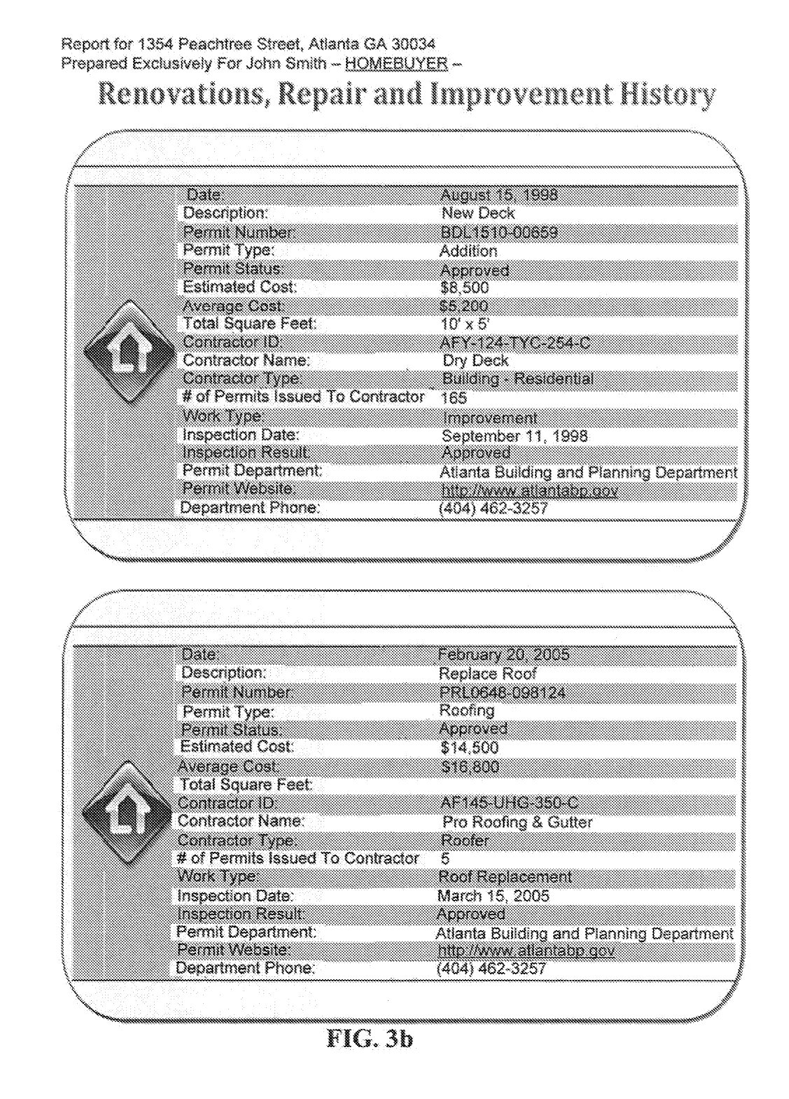

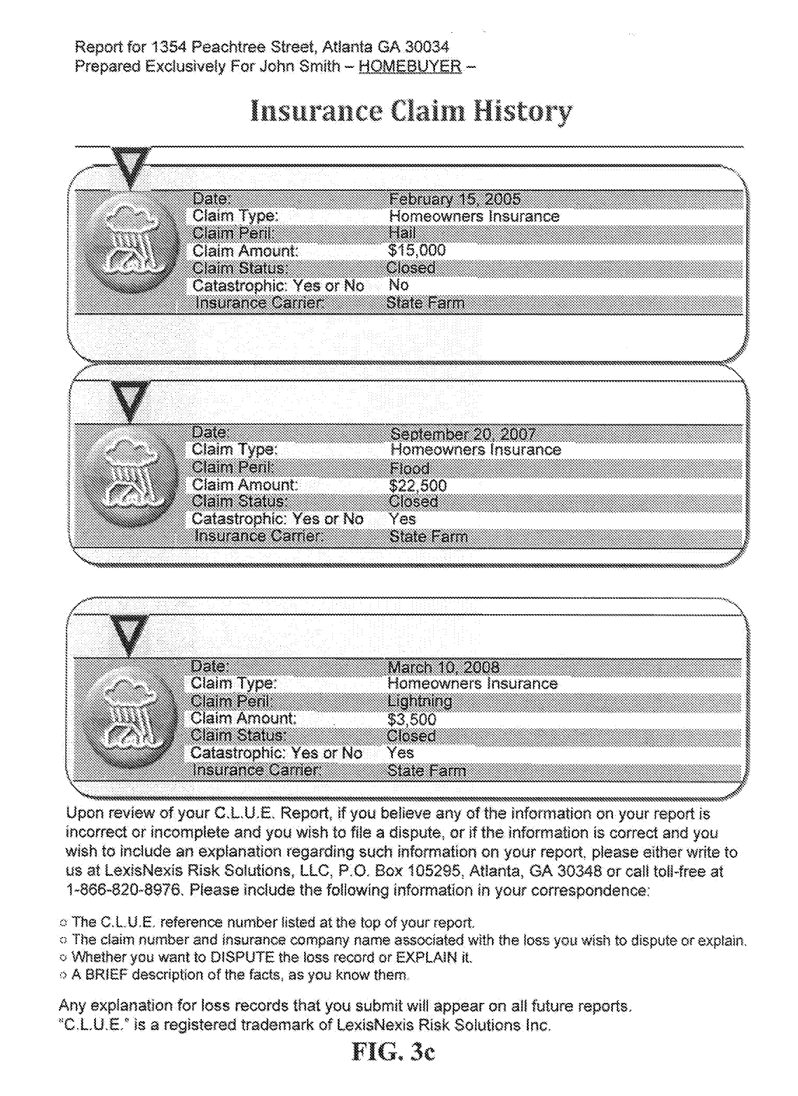

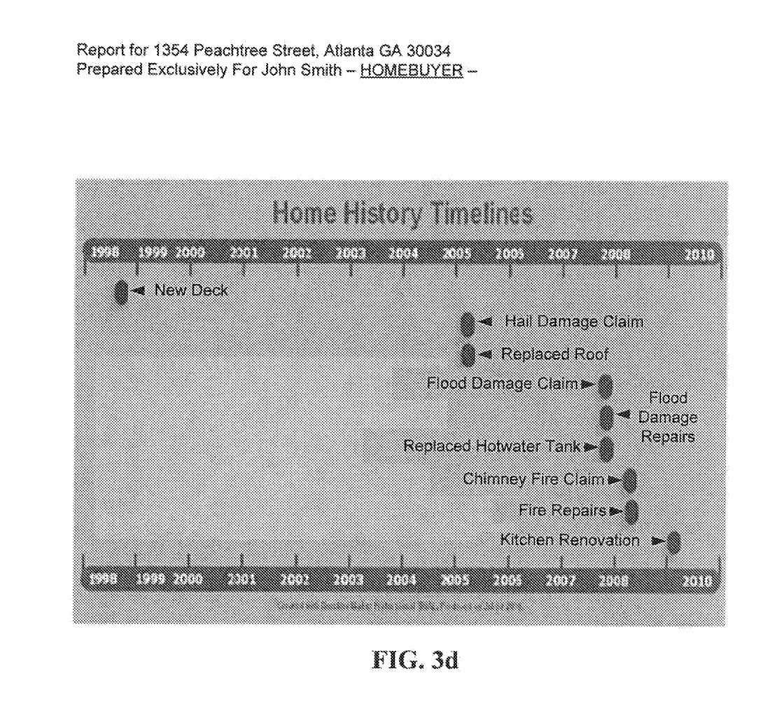

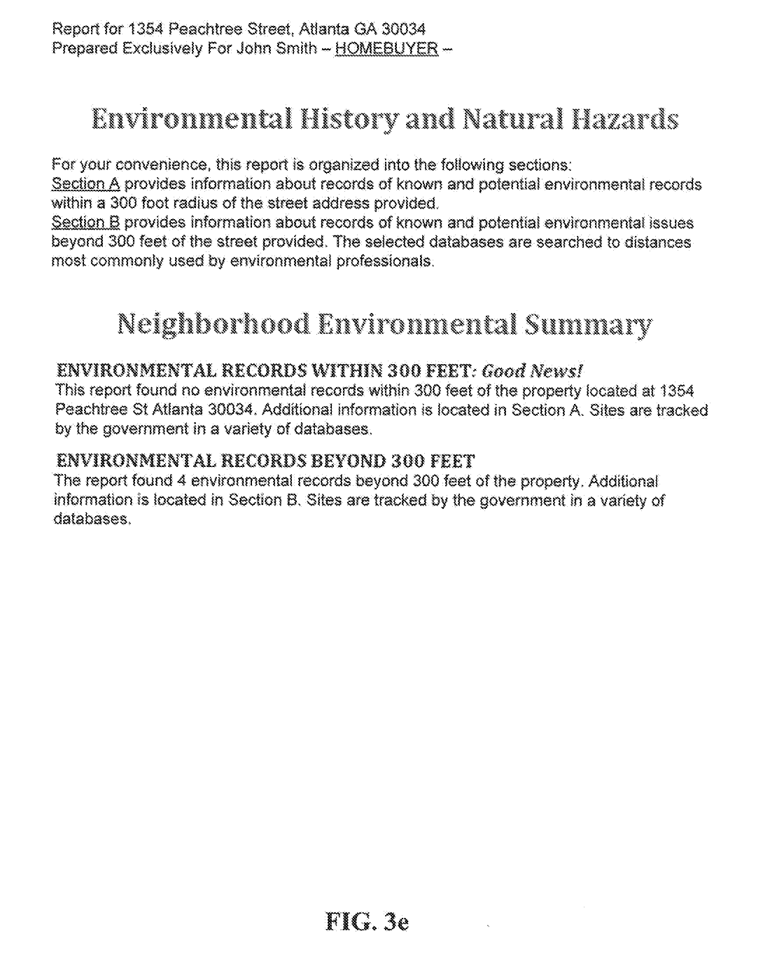

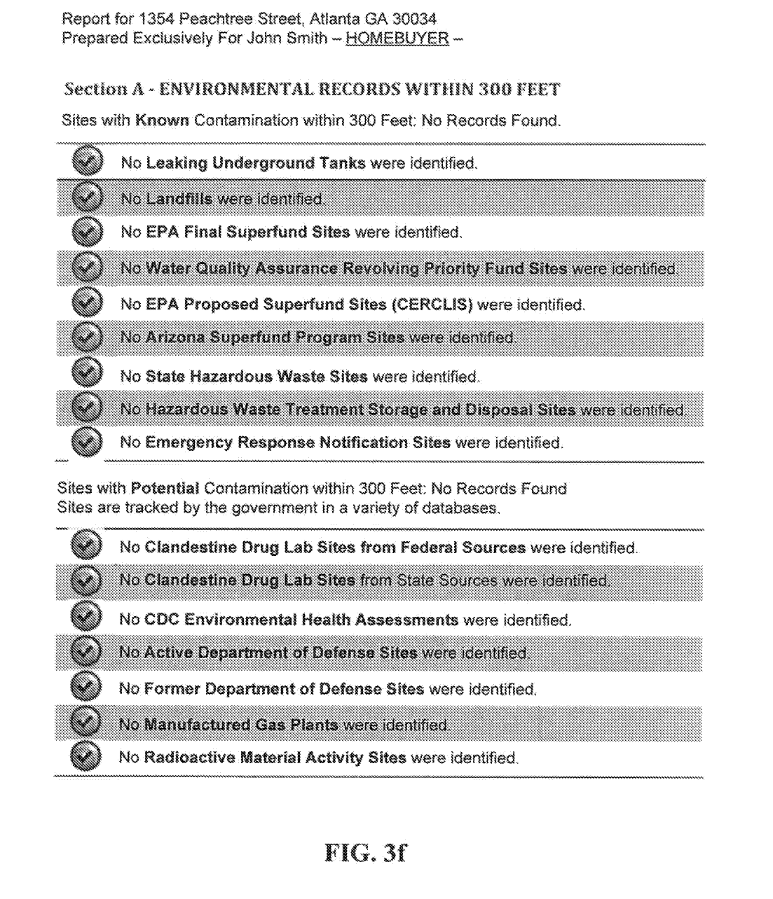

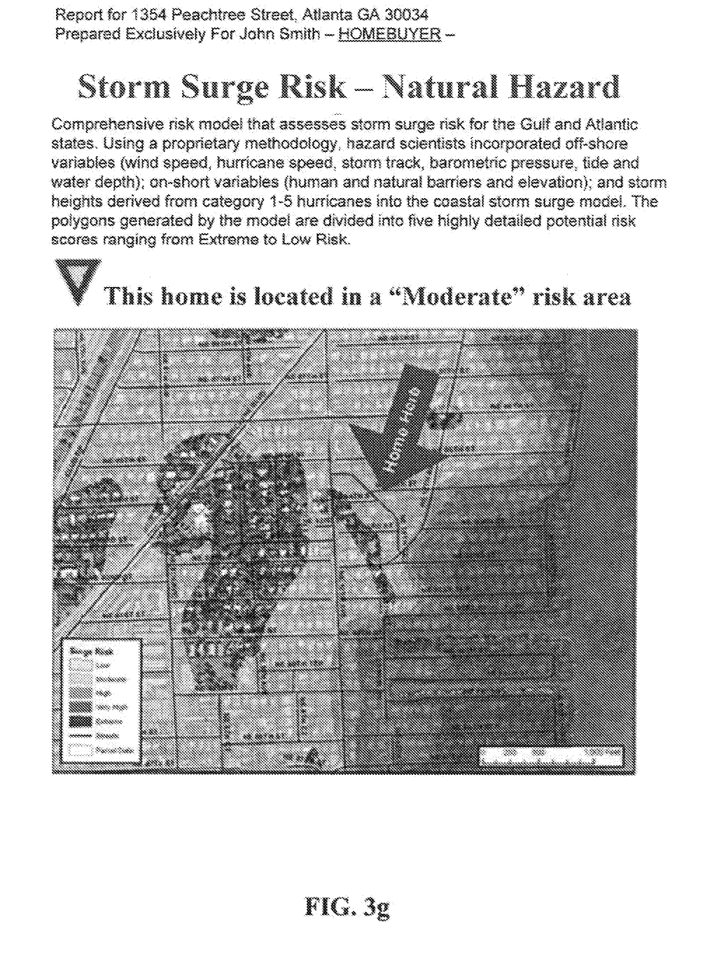

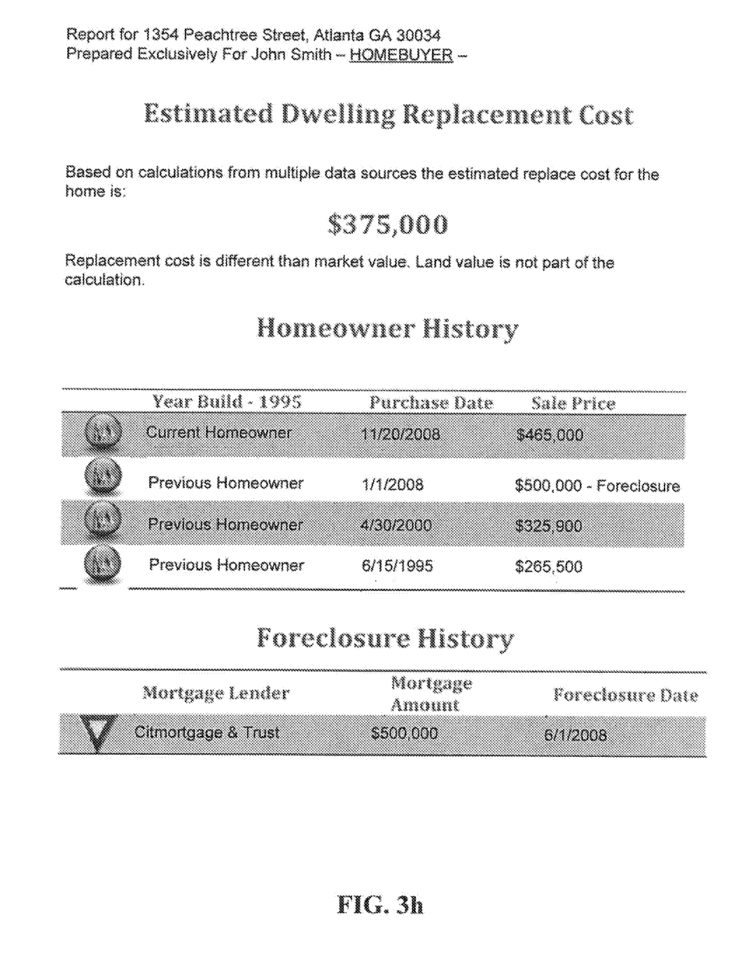

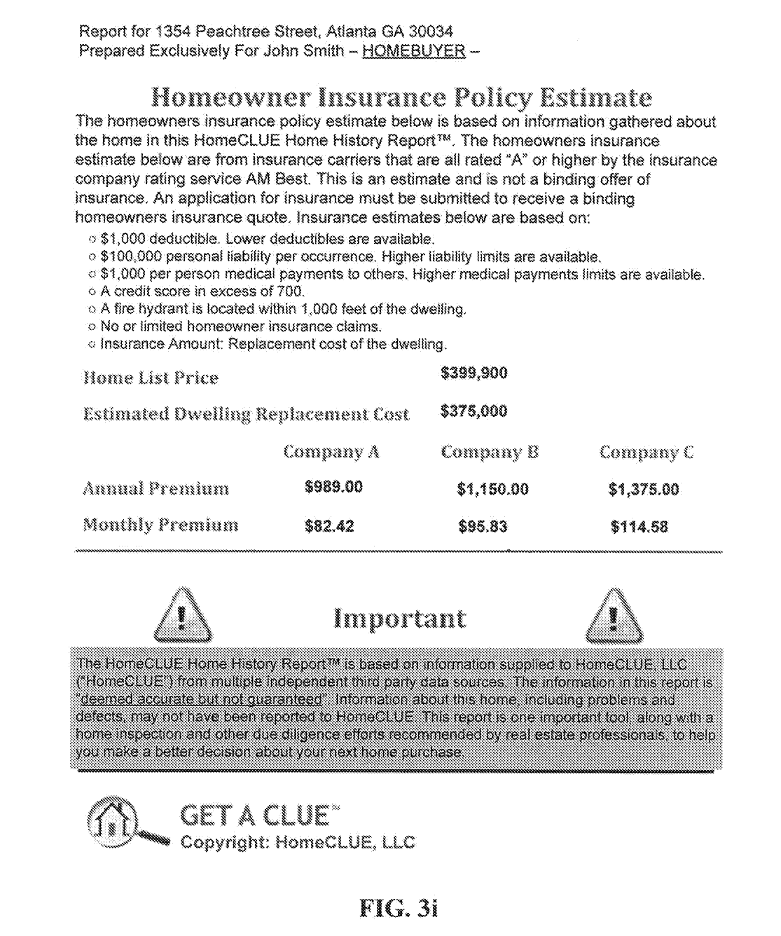

A sample report from the report generator 70 is shown in FIGS. 3a through 3i. With reference to FIG. 3a, there is shown a cover page of the exemplary report which identifies the property as “1354 Peachtree St Atlanta 30034” and summarizes the report through number of transactions which have occurred for the various home history categories. Alternatively, icons which show the symbols used to indicate whether a particular item is a problem or okay and the other contents of the report, including in this example the homeowner history, the sales price history, the building permit history, and the adverse claim history may all be included. The report may also be customized based on location, price, or subscriber preference.

Turning to FIG. 3b, there is shown another exemplary page of the home history report. In this page, there is shown a summary of “Renovations, Repair and Improvement History”. This history includes among other things the “Permit Date”, “Permit Number”, “Contractor”, “Cost” and “Work Type”. The “Work Type” may, for example, be listed as “Improvement” or “Roof Replacement” as shown in FIG. 3b. Other work types may include “Fire”, “Flooring”, “Repairs” or any other work type.

FIG. 3c includes an insurance claim history, including three entries indicating that insurance claims were filed for “Hail” on Feb. 15, 2005, “Flood” on Sep. 20, 2007 and “Lightning” on Mar. 10, 2008. The symbol to the left of each item indicates that the area is flagged for further investigation. This information may, for example, be used by a home inspector to focus attention on particular areas or by the prospective purchaser in interviewing the seller, the seller's neighbors, or the seller's real estate agent. There is also a value amount listed and a summary of the insurance claim listed, including the identification of the insurer.

Continuing with another exemplary page shown in FIG. 3d, there is shown a timeline for the home history, including all of the relevant events from the home history report. It will be understood that the format of the information in a timeline is exemplary only. Continuing with FIGS. 3e and 3f, there is shown the relevant environmental hazards. In this example, the environmental data is divided between environmental records within 300 feet of the home and beyond 300 feet of the home. FIG. 3g illustrates the risk associated with a storm surge based on the location and elevation of the home. The potential for other natural hazards may also be considered, including, for example, the risk of impacts due to wildfires or floods. Other history events may include, for example, a history of the various homeowners since the home was constructed, including the purchase date and the sales price, including foreclosure history as shown in FIG. 3h. This information may, for example, be useful for title search and clearance and title insurance purposes. Finally, FIG. 3i shows insurance quotes from at least one insurer indicating the premiums to be charged and the coverage obtained for those premiums.

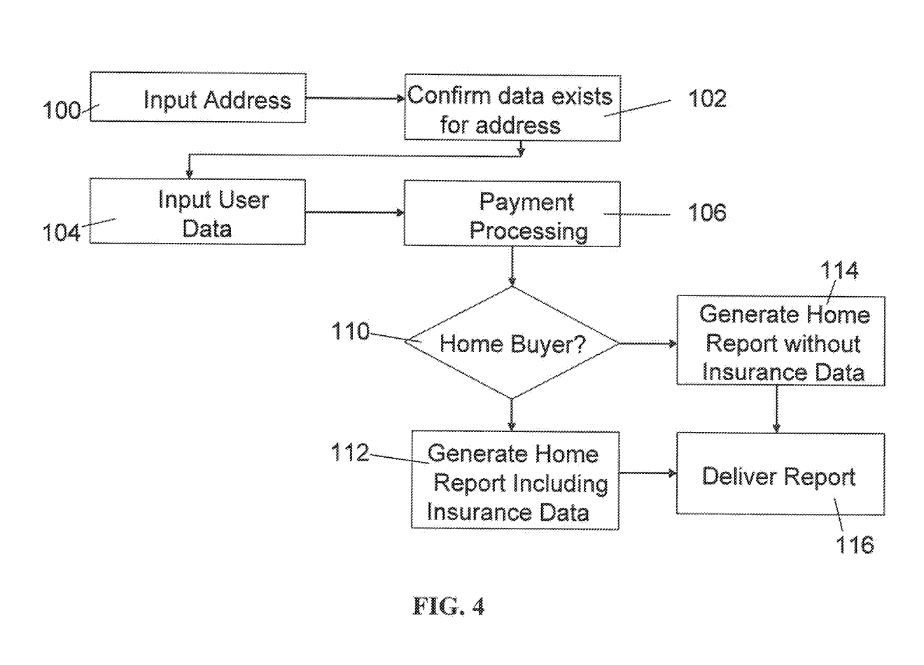

Turning now to FIG. 4, there is shown and exemplary process flow. The process starts at step 100 where a user would input the address or other identifier of the property to be analyzed. At step 102, the data processing system confirms that the identifier is valid and that home history data is available for that property. At step 104, the user inputs identifying user data, which may, for example, include information such as the user's name, contact information, email address, demographic data, and an indicator as to whether the user is a home owner, a prospective purchaser, or other party. In addition to use for this transaction, the user data may be used for targeted advertising or statistical analysis. At step 106, payment for the report is processed which transaction may, for example, be paid for by credit card, on-line check, vouchers or coupons, PayPal®, or any other transaction payment processing system. At step 110, a decision block indicates whether the user is the prospective home purchaser. If the user is a prospective home purchaser and authenticated as such, a report is generated at step 112 which includes the home history report as well as insurance claim and insurance quote information. If the user is not a prospective home purchaser or not authenticated as such at step 110, then a report is generated at step 114 which includes the home history report without insurance claim and insurance quote information. Finally, a report is delivered to the user at step 116 which may, for example, be an online report accessible through a personal customizable portal with user login credentials or a report emailed or printed and delivered in hard copy form to the user.

While example embodiments of a data processing application system configured to accommodate the functionality described herein have been described in connection with various computing devices/processor, the underlying concepts can be applied to any computing device, processor, or system capable of executing the described functionality. The various techniques described herein can be implemented in connection with hardware or software or, where appropriate, with a combination of both. Thus, the methods and apparatuses for a system configured to perform the functionality described herein, including but not limited to the home history generation, authentication, and reporting functions, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for accommodating a executing the functionality described. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods associated with a device configured to perform the described functionality may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus performing the described functionality. When implemented on a general-purpose processor, the program code combines with the processor to provide a unique apparatus that operates to invoke the functionality. Additionally, any storage techniques used in connection with a device configured to perform the described functionality can invariably be a combination of hardware and software.

While the system and method for generating a comprehensive home or real property report has been described in connection with the various embodiments of the various figures, it is to be understood that other similar embodiments can be used or modifications and additions can be made to the described embodiment for performing the same types of functionality in service delivery without deviating therefrom. For example, one skilled in the art will recognize that the system and method is not limited to any particular type of computer architecture or computer network may be used, including applications running on mobile terminals on various types of wireless networks, including but not limited to GSM, CDMA, EDGE, 3G, 4G, LTE, WiFi, and Wi-Max. Moreover, in addition to the Internet any other wired or wireless network may be used. Finally, reports generated may take multiple formats and include a variety of information customized for a particular purpose or user group. Therefore, the system and method should not be limited to any single embodiment, but rather should be construed in breadth and scope in accordance with the appended claims.

What is claimed:

1. A system for creating a report, comprising:
a data processor configured (i) to retrieve public information from publicly available data sources and (ii) to retrieve private information from a private date source, each of which is based upon input from a user;
an interface to an retrieve insurance quote based upon the input; and
wherein the server is further configured to generate a report comprising the public information and private information and the insurance quote.

2. The system of claim 1 further comprising an authentication system configured to qualify the user for access to the private information.

3. The system of claim 1 further comprising an application programming interface configured to provide access to the server by a third party application.

4. The system of claim 1 further comprising an e-commerce module configured to execute a business transaction relating to the report.

5. The system of claim 1 wherein the private information is an insurance history.

6. A method of generating a home report comprising:
requesting data from publicly available data sources;
obtaining an insurance quote;
receiving insurance history information;
generating a report comprising the data from publicly available data sources, the insurance history information, and the insurance quote.

7. The method of claim 6 further comprising authenticating the user as a prospective purchaser and wherein the receiving insurance history information step is performed responsive to the authentication step.

8. A method of generating a home report comprising:
requesting data from publicly available data sources;
obtaining data from data sources not generally available to the public; and
generating a report comprising the data from publicly available data sources and the data sources not generally available to the public.

9. The method of claim 8 further comprising authenticating the user as a prospective purchaser and wherein the obtaining step is performed responsive to the authentication step.

10. A tangible storage medium having stored thereon computer-executable instructions for generating a home history report, by:
requesting data from publicly available data sources;
obtaining an insurance quote;
receiving insurance history information;
generating a report comprising the data from publicly available data sources, the insurance history information, and the insurance quote.

11. The tangible storage medium of claim 10 wherein the computer-executable instructions also include authenticating the user as a prospective purchaser and wherein the receiving insurance history information step is performed responsive to the authentication step.
